(19) United States
(12) Patent Application Publication
(10) Pub. No.: US 2023/0041659 A1
(43) Pub. Date: Feb. 9, 2023

(54) METHOD AND APPARATUS TO TRANSMIT MESSAGES FOR BIT RATE QUERY AND RECOMMENDATION OVER UE-TO-NETWORK RELAY

(71) Applicant: MediaTek Inc., Hsin-Chu (TW)

(72) Inventors: Guan-Yu Lin, Hsin-Chu (TW); Xuelong Wang, Beijing (CN); Nathan Edward Tenny, San Jose, CA (US); Chia-Chun Hsu, Hsin-Chu (TW)

(21) Appl. No.: 17/877,307

(22) Filed: Jul. 29, 2022

Related U.S. Application Data
(63) Continuation of application No. PCT/CN2021/110298, filed on Aug. 3, 2021.

(30) Foreign Application Priority Data
Jul. 20, 2022 (CN) 202210855683.3

(51) Int. Cl. H04W 28/02

(52) U.S. Cl. CPC H04W 28/0268; H04W 88/04

(57) ABSTRACT

A method is provided to support remote UE transmitting recommended bit rate query to the base station via the processing of relay UE. In one novel aspect, a new sidelink MAC CE is introduced to indicate the desired bit rate for a specific sidelink logical channel or for a specific Uu/SL radio bearer. In one novel aspect, after receiving the recommended bit rate query MAC CE, the relay UE forwards the MAC CE of this remote UE to the base station over Uu interface after adding information related to remote UE identity. In one novel aspect, the recommended bit rate query MAC CE, when received by the relay UE, is mapped to a specific uplink logical channel priority value or a specific uplink logical channel priority level, which can be used to compare priority with other UL data or UL MAC CE.

### CROSS REFERENCE TO RELATED APPLICATIONS

§ 111(a) and is based on and hereby claims priority under 35 U.S.C. § 120 and § 365(c) from International Application No. PCT/CN2021/110298, entitled “METHOD AND APPARATUS TO TRANSMIT MESSAGES FOR BIT RATE QUERY AND RECOMMENDATION OVER UE-TO-NETWORK RELAY,” filed on Aug. 3, 2021. This application claims priority under 35 U.S.C. § 119 from Chinese Application Number CN202210855683.3, filed on Jul. 20, 2022. The disclosure of each of the foregoing documents is incorporated herein by reference.

### TECHNICAL FIELD

The disclosed embodiments relate generally to wireless network communications, and, more particularly, to enable end-to-end MAC CE transmission between remote UE and gNB over layer 2 UE-to-Network relay in 5G new radio (NR) wireless communications systems.

### BACKGROUND

New technologies in 5G new radio (NR) allow cellular devices to connect directly to one another using a technique called sidelink (SL) communications. Sidelink is the new communication paradigm in which cellular devices are able to communicate without relaying their data via the network. The sidelink interface may also be referred to as a PC5 interface. A variety of applications may rely on communication over the sidelink interface, such as vehicle-to-everything (V2X) communication, public safety (PS) communication, direct file transfer between user devices, and so on. To support sidelink relay, there are two kinds of UE-to-Network Relay architecture, i.e., Layer 2 relay (L2 relay) and Layer 3 relay (L3 relay).

In case of L3 based Sidelink Relay, a Relay UE forwards data packet flow of a Remote UE as IP traffic as a general Router in data communication network. The IP traffic-based forwarding is conducted in a best-efforts way. For L3 UE-to-Network Relay, there exist both sidelink radio bearers (SLRBs) over PC5 and Uu Radio Bearers to carry the QoS flows established between Remote UE and 5GC. L3 UE-to-Network Relay can support flow-based mapping at SDAP layer when converting PC5 flow to Uu Flow, or vice versa, during traffic forwarding. Note that since L3 based Sidelink Relay UE works like an IP router, Remote UE is transparent to gNB, i.e., the gNB cannot know whether the traffic transmitted by a relay UE originates from this relay UE itself, or originates from a remote UE but is forwarded by this relay UE.

In contrast, in case of L2 based SL Relay, relaying is performed above RLC sublayer via Relay UE for both control plane (CP) and user plane (UP) between Remote UE and network. Uu SDAP/PDCP and RRC are terminated between Remote UE and gNB, while RLC, MAC and PHY are terminated in each link (i.e., the link between Remote UE and UE-to-Network Relay UE and the link between UE-to-Network Relay UE and the gNB). An adaptation layer over RLC layer is supported in Uu to perform bearer mapping and it can be also placed over PC5 to perform bearer mapping at sidelink. The adaptation layer between the Relay UE and the gNB is able to differentiate between bearers (SRBs, DRBs) of a particular Remote UE. Within a Uu DRB, different Remote UEs and different bearers of the Remote UE can be indicated by additional information included in adaptation layer header. Unlike in L3 relay, the gNB is aware of each remote UE, and thus before the relay UE starts to forward normal data traffic, the end-to-end connection between a remote UE and the gNB should be established first. After establishing the RRC connection via SL relay, the remote UE can then forward data traffic based on the established bearers and the forwarding/router information carried in adaptation layer.

In NR, to enhance MMTEL (multimedia telephony) IMS (IP multimedia subsystem) voice and video, RAN-assisted codec adaptation is introduced. RAN-assisted codec adaptation provides a means for the gNB to send codec adaptation indication with recommended bit rate to assist the UE to select or adapt to a codec rate for MMTEL voice or MMTEL video. The RAN-assisted codec adaptation mechanism supports the uplink/downlink bit rate increase or decrease. For a bearer associated with configuration of MBR greater than GBR, the recommended uplink/downlink bit rate is within boundaries set by the MBR and GBR of the concerned bearer.

For uplink or downlink bit rate adaptation, gNB may send a recommended bit rate to the UE to inform the UE on the currently recommended transport bit rate on the local uplink or downlink, which the UE may use in combination with other information to adapt the bit rate, e.g. the UE may send a bit rate request to the peer UE via application layer messages, which the peer UE may use in combination with other information to adapt the codec bit rate. The recommended bit rate is in kbps at the physical layer at the time when the decision is made.

The recommended bit rate for UL and DL is conveyed as a MAC Control Element (CE) from the gNB to the UE. Based on the recommended bit rate from the gNB, a UE may initiate an end-to-end bit rate adaptation with its peer (UE or MGW). The UE may also send a query message to its local gNB to check if a bit rate recommended by its peer can be provided by the gNB. The UE is not expected to go beyond the recommended bit rate from the gNB. The recommended bit rate query message is conveyed as a MAC CE from the UE to the gNB.

MAC CE does not support SL relay forwarding. Most MAC CE are used to manage link between UE and gNB. However, a few MAC CEs are not used for link management, including (1) bit rate query and recommendation MAC CE and (2) UL BSR. The current SL relay design does not support MAC CE forwarding, and thus remote UE cannot tell gNB its preferred bit rate and its data in buffer.

A solution is sought.

### SUMMARY

A method is provided to support remote UE transmitting recommended bit rate query to the base station via the processing of relay UE. In one novel aspect, a new sidelink MAC CE is introduced to indicate the desired bit rate for a specific sidelink logical channel or for a specific Uu/SL radio bearer. In one novel aspect, after receiving the recommended bit rate query MAC CE, the relay UE forwards the MAC CE of this remote UE to the base station over Uu interface after adding information related to remote UE identity. In one novel aspect, the recommended bit rate query MAC CE, when received by the relay UE, is mapped to a specific uplink logical channel priority value or a specific uplink logical channel priority level, which can be used to compare priority with other UL data or UL MAC CE.

A method is also provided for a base station to transmit recommended bit rate to a remote UE. In one novel aspect, the recommended bit rate MAC CE for a remote UE is transmitted along with the identity of the remote UE from the base station to the relay UE. In one novel aspect, after relay UE receives the recommended bit rate MAC CE, the relay UE forwards the MAC CE to the targeted remote UE according to the associated identity of remote UE. In one novel aspect, the recommended bit rate MAC CE has a fixed or configured sidelink logical channel priority value, and/or a related priority value comparable with other SL data and SL MAC CE.

Other embodiments and advantages are described in the detailed description below. This summary does not purport to define the invention. The invention is defined by the claims.

### BRIEF DESCRIPTION OF THE DRAWINGS

FIG. 1 illustrates a wireless mobile communication system supporting uplink and downlink MAC control element (CE) forwarding through sidelink (SL) relay in accordance with a novel aspect.

FIG. 2 is a simplified block diagram of a wireless transmitting device and a receiving device in accordance with embodiments of the current invention.

FIG. 3 illustrates one embodiment of recommended bit rate query and recommended bit rate messages forwarded via RLC SDU in accordance with one novel aspect.

FIG. 4 illustrates one embodiment of recommended bit rate query message forwarded via UL MAC CE in accordance with one novel aspect.

FIG. 5 illustrates one embodiment of recommended bit rate message forwarded via DL MAC CE in accordance with one novel aspect.

FIG. 6 illustrates one embodiment of SL MAC CE forwarding in UE-to-UE relay in accordance with one novel aspect.

FIG. 7 illustrates one example of an SL MAC PDU format with SL-SCH MAC sub-header for MAC CE forwarding in accordance with one novel aspect.

FIG. 8 illustrates one embodiment of UL MAC CE forwarding over UE-to-network SL relay in accordance with one novel aspect.

FIG. 9 illustrates one embodiment of DL MAC CE forwarding over UE-to-network SL relay in accordance with one novel aspect.

FIG. 10 is a flow chart of a method of MAC CE forwarding a recommend bit rate query message through sidelink relay in accordance with one novel aspect.

FIG. 11 is a flow chart of a method of MAC CE forwarding a recommend bit rate message through sidelink relay in accordance with one novel aspect.

### DETAILED DESCRIPTION

Reference will now be made in detail to some embodiments of the invention, examples of which are illustrated in the accompanying drawings.

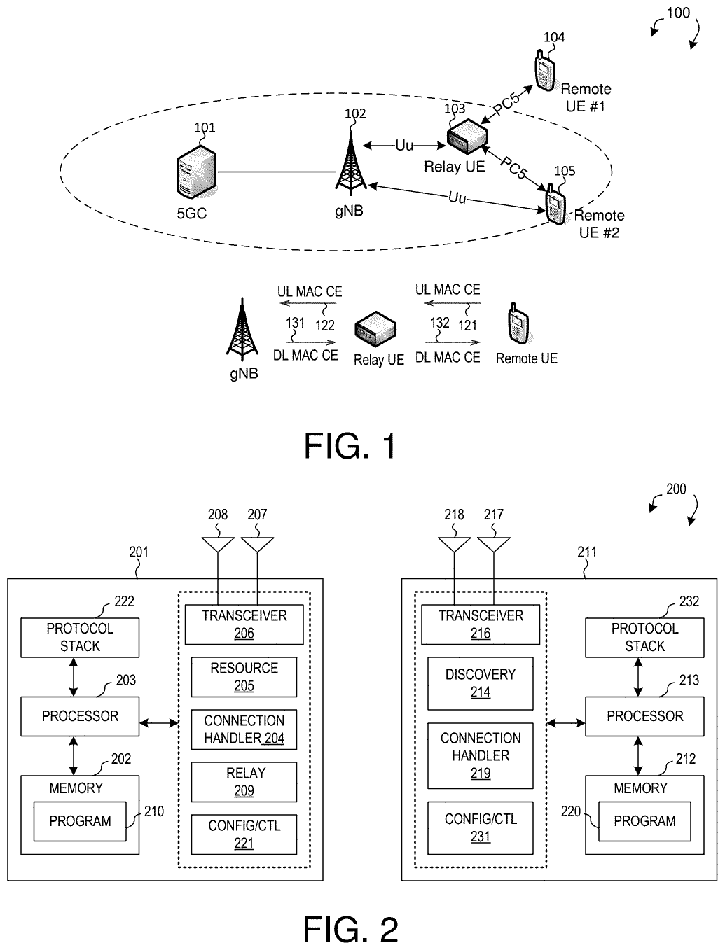

FIG. 1 illustrates a wireless mobile communication system 100 supporting uplink and downlink MAC CE forwarding through sidelink (SL) relay in accordance with a novel aspect. 5G new radio (NR) mobile communication network 100 comprises a 5G core (5GC) 101, a next generation base station gNB 102, and a plurality of user equipments UE 103, UE 104, and UE 105. For in-coverage UEs, a base station can schedule data traffic over Uu link. For out-of-coverage UEs, a relay UE can schedule data traffic over PC5 (or sidelink (SL)). In FIG. 1, UE 103 is a radio resource control (RRC)-connected UE that acts as a mobile device relay using PC5 (or SL) to relay data traffic to/from end remote UEs for coverage extension. Remote UE 104 is out of network coverage. Relay UE 103 helps to relay all data traffic for remote UE 104. Remote UE 105 is connected to the network via Uu link, but the link quality may be poor. Relay UE 103 helps to relay part or all data traffic for remote UE 105. Relay UE 103 operates to relay communications between UE 104/105 and the network, thus allowing the network to effectively extend its coverage to the remote UEs.

To support sidelink relay, there are two kinds of UE-to-Network Relay architecture, i.e., Layer 2 relay (L2 relay) and Layer 3 relay (L3 relay). However, MAC Control Element (CE) does not support sidelink relay forwarding. Although most MAC CEs are used to manage links between UE and gNB, a few MAC CEs are not used for link management, including (1) bit rate query and recommendation MAC CE and (2) UL buffer status report (BSR). For example, the recommended bit rate for uplink and downlink is conveyed as a MAC CE from the gNB to the UE, and the recommended bit rate query message is conveyed as a MAC CE from the UE to the gNB. The current SL relay design, however, does not support such MAC CE forwarding.

In accordance with one novel aspect, a method is proposed to allow uplink and downlink MAC CE forwarding through sidelink relay. As illustrated in FIG. 1, in the uplink (UL), a recommended bit rate query message is sent from a remote UE and forwarded to a gNB via a relay UE over a new UL MAC CE (step 121). The relay UE forwards the new UL MAC CE of the remote UE to the gNB after adding information related to the remote UE identity (step 122). Similarly, in the downlink (DL), a recommended bit rate DL MAC CE for the remote UE is transmitted along with the identity of the remote UE from the gNB to the relay UE (step 131) and then forwarded to the remote UE by the relay UE (step 132).

FIG. 2 is a simplified block diagram of wireless devices 201 and 211 in accordance with a novel aspect. For wireless device 201 (e.g., a relay UE), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a remote UE), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the device 211.

The wireless devices 201 and 211 also include several functional modules and circuits that can be implemented and configured to perform embodiments of the present invention. In the example of FIG. 2, wireless device 201 is a relay UE that includes a protocol stack 222, a resource management circuit 205 for allocating and scheduling sidelink resources, a connection handling circuit 204 for establishing and managing connections, a relay handling controller 209 for relaying all or part of control signaling and/or data traffic for remote UEs, and a control and configuration circuit 221 for providing control and configuration information. Wireless device 211 is a remote UE that includes a protocol stack 232, a relay discovery circuit 214 for discovering relay UEs, a connection handling circuit 219 for establishing and managing connections, and a configuration and control circuit 231. The different functional modules and circuits can be implemented and configured by software, firmware, hardware, and any combination thereof. The function modules and circuits, when executed by the processors 203 and 213 (e.g., via executing program codes 210 and 220), allow relay UE 201 and remote UE 211 to perform embodiments of the present invention accordingly.

In case of L2 based SL Relay, relaying is performed above RLC sublayer via Relay UE for both control plane (CP) and user plane (UP) between Remote UE and network. Uu SDAP/PDCP and RRC are terminated between Remote UE and gNB, while RLC, MAC and PHY are terminated in each link (i.e., the link between Remote UE and UE-to-Network Relay UE and the link between UE-to-Network Relay UE and the gNB). An adaptation layer over RLC layer is supported in Uu to perform bearer mapping and it can be also placed over PC5 to perform bearer mapping at sidelink. The adaptation layer between the Relay UE and gNB is able to differentiate between bearers (SRBs, DRBs) of a particular Remote UE. Within a Uu DRB, different Remote UEs and different bearers of the Remote UE can be indicated by additional information included in adaptation layer header. In one example, a remote UE can transmit a recommended bit rate query MAC CE to a base station via the processing of a relay UE. In another example, the remote UE can receive a recommended bit rate MAC CE from the base station via the processing of the relay UE.

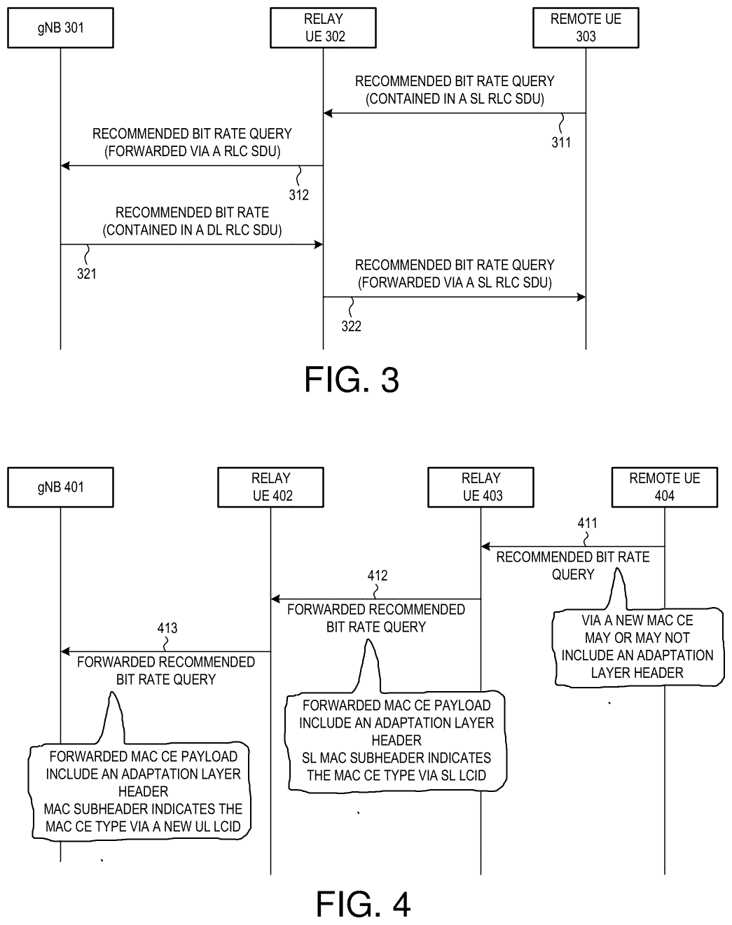

FIG. 3 illustrates one embodiment of recommended bit rate query and recommended bit rate messages forwarded via RLC SDU in accordance with one novel aspect. In L2 relay, the base station is aware of each remote UE connecting to the base station via relay UEs. The recommended bit rate query, aiming to enhance the QoS for MMTEL voice and video, is for an end-to-end application. Thus, to ensure good end-to-end QoS, it would be preferred that the gNB clearly knows the desired bit rate of each remote UE. To transmit the recommended bit rate query, a remote UE sends the desired bit rate to the base station via relay UE.

In the embodiment of FIG. 3, a recommended bit rate query message is carried by control signaling, e.g., via a RLC SDU over UL-DCCH. For example, the information of recommended bit rate query may be included in an existing RRC signaling such as a SidelinkUEInformation message, or a UEAssistanceInformation message, or a new RRC message, and the RRC signaling is included in a RLC SDU and to be transmitted from remote UE 303 (step 311) to the base station 301 via the forwarding of relay UE 302 (step 312). In this embodiment, the recommended bit rate query message is transmitted via dedicated signaling (i.e., the same way as how a remote UE sends UL data to a base station via L2 SL relay).

Similarly, the base station may send recommended bit rate to a remote UE to suggest the suitable bit rate. In L2 relay, since gNB is aware of the existence of each remote UE, the information of recommended bit rate from gNB should be received by the remote UE. In one embodiment, as illustrated in FIG. 3, a recommended bit rate message is carried by control signaling, e.g., via a RLC SDU over DL-DCCH which will then be forwarded by the relay UE over sidelink to the remote UE. For example, the information of recommended bit rate may be included in an existing RRC signaling such as RRCReconfiguration message, and the RRC signaling is included in a RLC SDU and to be transmitted from gNB 301 (step 321) to remote UE 303 via the forwarding of relay UE 302 (step 322). In this embodiment, the recommended bit rate is transmitted via dedicated signaling (i.e., same way as how the base station sends DL data to a remote UE via L2 SL relay).

FIG. 4 illustrates one embodiment of recommended bit rate query forwarded via UL MAC CE in accordance with one novel aspect. If the desired bit rate is carried by a sidelink MAC CE, there are different ways to transmit it from remote UE 404 to relay UE 403 (step 411). In one embodiment, the sidelink MAC CE for recommended bit rate query, like other sidelink MAC CE, is multiplexed into a SL MAC PDU according to the legacy LCP and multiplexing procedure. In one embodiment, the sidelink MAC CE for recommended bit rate query is treated as a typical SL RLC SDU data. That is, a MAC subPDU is formed by adding an adaptation layer header, optionally adding an SL RLC header, and adding an MAC subheader, whose LCID value indicated in the LCID field and/or eLCID field tells the receiver that this MAC subPDU is to carry recommended bit rate query. Then, this MAC subPDU including the recommend bit rate query is forwarded from remote UE 404 to gNB 401 via relay UE 403 and relay UE 402.

After a relay UE receives the recommended bit rate query, there are several ways to handle the query. In one embodiment, if the recommended bit rate query is carried in a format of SL MAC CE without associated RLC header or adaptation layer header, the relay UE may consider the SL MAC CE as a RLC SDU. That means the relay UE adds adaptation layer header and RLC header in front of the SL MAC CE payload to form a RLC PDU, and then transmit to gNB by applying legacy Uu LCP procedure. When the RLC PDU is multiplexed into an UL MAC PDU, the MAC subheader associated with the RLC PDU for recommend bit rate query may include an UL LCID value corresponding for “recommend bit rate query MAC CE from remote UE”. For multi-hop scenario, the relay UE 403 may package the SL MAC CE to be a SL RLC PDU, and then transmit it to the upstream relay UE 402 by applying legacy sidelink LCP procedure. Similarly, the MAC subheader for the SL RLC SDU has a LCID to identify the content of RLC SDU as a recommended bit rate query MAC CE. In one example, the added adaptation layer header includes identity of the remote UE who initiates the query.

In one embodiment, if the recommended bit rate query is carried in a format of SL MAC CE with associated RLC header or adaptation layer header, a relay UE updates the RLC header and adaptation layer header, and then forwards the updated RLC PDU to the next hop (i.e., gNB or the upstreaming relay UE). If the relay UE 402 forwards the RLC PDU to gNB 401 (step 413), the MAC subheader of the RLC PDU indicates the LCID value corresponding to recommended bit rate query MAC CE from remote UE. In contrast, if the relay UE 403 forwards the RLC PDU to the upstream relay UE 402 (step 412), the SL MAC subheader of the RLC PDU indicates the LCID value corresponding to recommended bit rate query SL MAC CE.

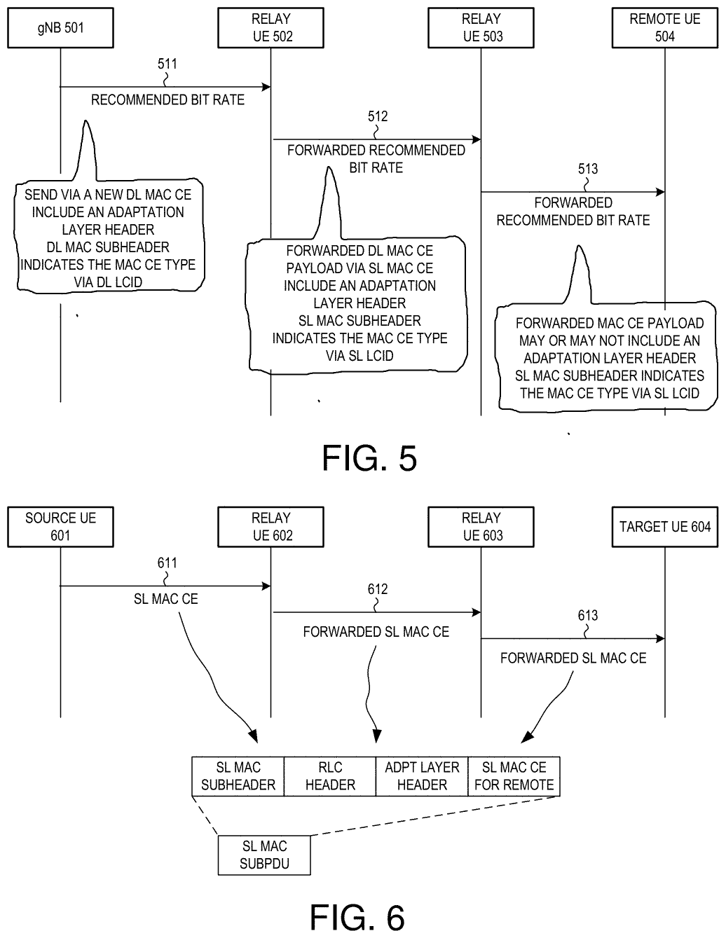

FIG. 5 illustrates one embodiment of recommended bit rate forwarded via DL MAC CE in accordance with one novel aspect. A new MAC CE type may be specified to carry a recommended bit rate message from a gNB to a remote UE. This MAC CE type may have its own downlink LCID value specified by the LCID field or both the LCID field and e-LCID field in the MAC subheader (step 511). In case the MAC subheader indicates the LCID value corresponding to the recommended bit rate MAC CE for a remote UE, the corresponding MAC CE payload includes the information of the remote UE, e.g., remote UE ID.

In one example, to send recommended bit rate for a remote UE, the gNB put the information of the targeted remote UE (e.g., target remote UE ID) in the adaptation layer header, while other information mentioned above is included in the payload of a MAC CE. For example, the gNB may treat the MAC CE payload as a RLC SDU, and thus sequentially adds adaptation layer header, optionally RLC header, and MAC subheader for it to form a MAC subPDU. After relay UE receives a DL MAC PDU including the MAC subPDU, the relay UE knows that this MAC subPDU carries a recommended bit rate MAC CE towards a remote UE by checking the LCID value indicated in LCID and/or eLCID field in the MAC subheader. The relay UE then updates the RLC header (if exist and needed) and adaptation layer header (if needed), and forwards the SL RLC SDU to the remote UE (step 513) or the downstream relay UE (step 512). When multiplexing the SL RLC SDU to a SL MAC PDU, the SL MAC subheader associated with the SL RLC SDU includes an LCID value corresponding to recommended bit rate MAC CE over sidelink. Note that similar to recommended bit rate query MAC CE over sidelink, the recommended bit rate MAC CE over sidelink has its unique LCID value.

There are two ways for a relay UE to forward the recommended bit rate MAC CE to the remote UE. In one embodiment, the MAC CE payload, along with the adaptation layer header, optionally the RLC header, and the MAC subheader forms a SL MAC subPDU and is sent by relay UE to the remote UE. From the LCID for the MAC subheader of the MAC subPDU, remote UE knows that this is a recommended bit rate MAC CE, and removes RLC header and adaptation layer header to read the MAC CE payload. In one embodiment, only the MAC CE payload and the MAC subheader forms a MAC subPDU. Upon receiving the MAC subPDU, from the LCID for the MAC subheader of the MAC subPDU, remote UE knows that this is a recommended bit rate MAC CE.

FIG. 6 illustrates one embodiment of SL MAC CE forwarding in UE-to-UE relay in accordance with one novel aspect. The framework for the network and a remote UE to exchange UL MAC CE or DL MAC CE via relay UE(s) can also be applied to the scenario of UE-to-UE relay. For UE-to-UE relay, SL MAC CE is forwarded via relay UE(s), rather than forwarding UL or DL MAC CE. How SL MAC CE is forwarded is very similar to UL and DL MAC CE in a UE-to-Network relay. An adaptation layer header (e.g., for routing purpose) can be added for a SL MAC CE to form a SL MAC subPDU. Besides, an indicator can be used to indicate that this SL MAC subPDU includes a (certain type of) SL MAC CE, e.g., apply a specific sidelink LCID value in the MAC subheader of the SL MAC subPDU.

For SL MAC CE forwarding, since both the source and the target of a SL MAC CE are UEs, the adaptation layer header needs to include both the source UE ID and the target UE ID, so that the target UE can know who initiates the SL MAC CE by the source UE ID. In the example of FIG. 6, the SL MAC CE is packaged into a SL MAC subPDU, sent from source UE 601 (step 611), and is forwarded from source UE based on the routing information (including source ID and target ID) of the adaptation layer header, via relay UE 602 (step 612) and relay UE 603 (step 613) to the target UE 604.

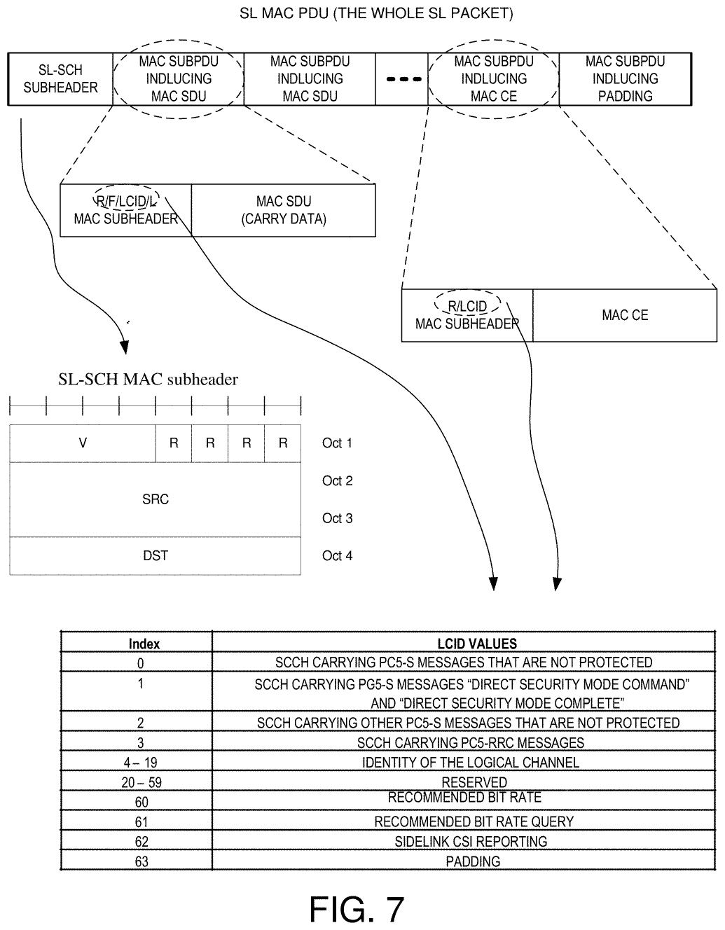

FIG. 7 illustrates one example of an SL MAC PDU format with SL-SCH MAC sub-header for MAC CE forwarding in accordance with one novel aspect. SL MAC PDU consists of SL-SCH MAC subheader, several MAC subPDUs, and padding. Each MAC subPDU carries either data or MAC CE. MAC subPDU for data comprises a MAC subheader and a MAC SDU. MAC subheader format for data has a field “L” to indicate the size (bytes number) of the MAC SDU. MAC subPDU for MAC CE comprises a MAC subheader and a MAC CE. MAC subheader format for MAC CE has no field “L” because currently all supported SL MAC CE has a fixed size.

The SL-SCH MAC subheader comprises a SRC field and a DST field, used to indicate who send the SL MAC PDU (SRC) and who should receive the SL MAC PDU (DST). For example, if an SL MAC PDU is sent from remote UE, to relay UE2, to relay UE1, and to gNB, then when remote UE send the SL MAC PDU over SL, the DST field is relay UE2, and when relay UE2 forwards the SL MAC PDU, the SRC field is relay UE2, and the DST field is relay UE1.

LCID for SL-LCH is used to indicate the content of the payload in an SL MAC subPDU. For example, if the value of LCID is <20, then the payload is MAC SDU, and if the value of LCID is equal to 62, then the payload is a MAC CE for SL CSI reporting. In current MAC specification, there are two tables define the values of LCID for DL-LCH and UL-SCH. For example, the recommended bit rate DL message has LCID==47, and the recommended bit query UL message has LCID==53. In accordance with one novel aspect, two SL LCID values are added in LCID table for SL-SCH. First, “SL recommendation bit rate query MAC CE” for UE-to-gNB (uplink direction) with LCID==61 is added as a counterpart to “UL recommendation bit rate query MAC CE”. Second, “SL recommendation bit rate” for gNB-to-UE (downlink direction) with LCID==60 is added as a counterpart to “DL recommendation bit rate MAC CE”.

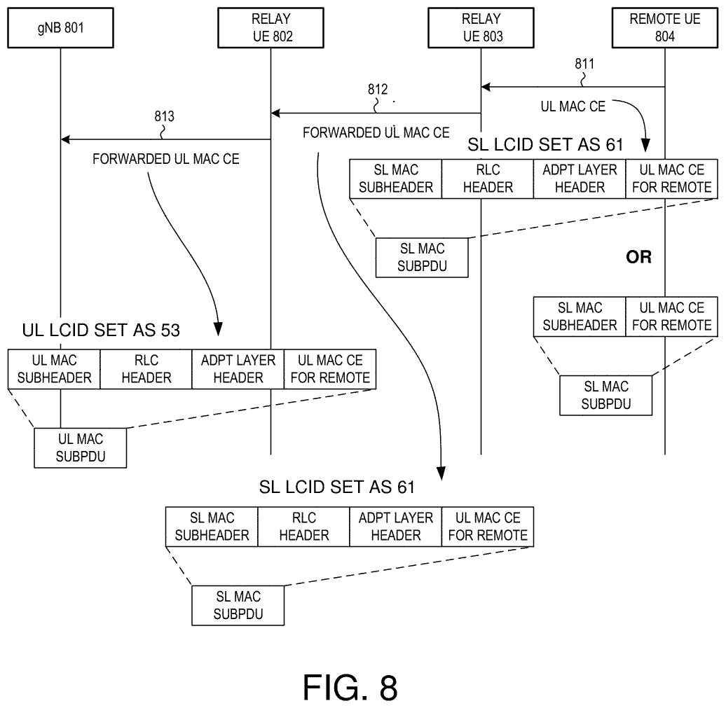

FIG. 8 illustrates one embodiment of UL MAC CE forwarding over UE-to-network SL relay in accordance with one novel aspect. In step 811, remote UE 804 sends an UL MAC CE to relay UE 803. In step 812, relay UE 803 forwards the UL MAC CE to relay UE 802. In step 813, relay UE 802 forwards the UL MAC CE to gNB 801. In this example, when a relay UE forwards recommended bit rate query of a remote UE to the base station, the UL LCID included in the MAC subheader of the recommended bit rate query MAC CE from remote UE should be different from the UL LCID for legacy recommended bit rate query MAC CE. Otherwise, gNB would assume that the recommend bit rate query comes from the relay UE itself and would fail to decode the content of MAC CE payload.

To distinguish the recommended bit rate query MAC CE for relay UE and for remote UE, the recommended bit rate query MAC CE for remote UE with a distinct SL LCID, e.g., SL LCID set as 61. Here, the UL MAC CE is referred to as “relay-specific recommended bit rate query” since it is used only in the SL relay scenario. When relay UE 802 checks SL MAC subheader and finds the SL LCID value is 61, relay UE 802 knows that this MAC payload includes MAC CE for “recommended bit rate query”, and thus in UL transmission (from relay 802 to gNB 801) relay UE 802 selects the UL LCID value for “recommended bit rate query”, i.e., 53 as specified in UL LCID table.

In this invention, method on how to deliver a UL MAC CE (recommended bit rate query MAC CE) from a remote UE to the base station is proposed. The main concept is that when forwarding a MAC CE, this MAC CE needs to add adaptation layer header for routing. With the addition of adaption layer header, additional LCID is needed. For example, to forward a UL MAC CE, a new UL LCID specific for relay is needed, so that when base station receives the UL MAC CE, the base station knows that this UL MAC CE comes from a remote UE, and knows the existence of adaptation layer header included in the MAC SDU.

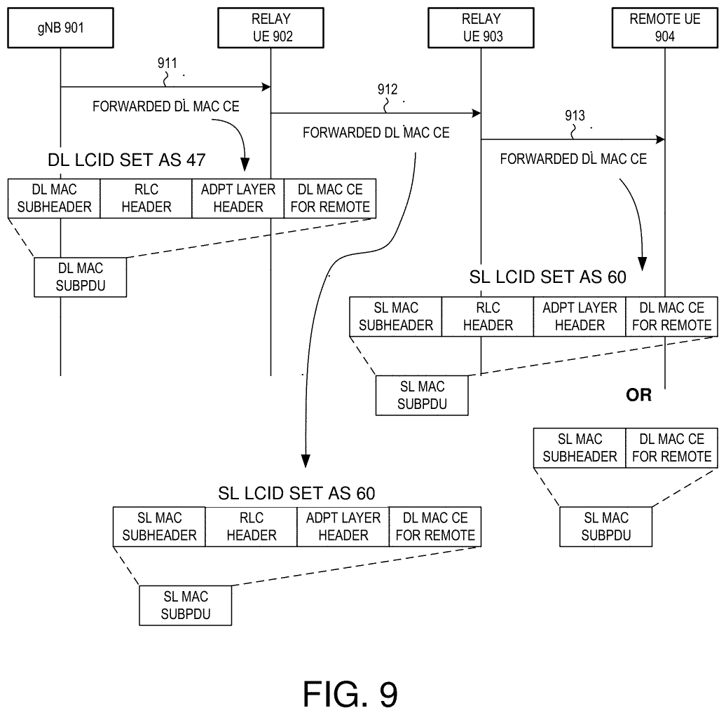

FIG. 9 illustrates one embodiment of DL MAC CE forwarding over UE-to-network SL relay in accordance with one novel aspect. In step 911, gNB 901 sends a DL MAC CE to relay UE 902. In step 912, relay UE 902 forwards the DL MAC CE to relay UE 903. In step 913, relay UE 903 forwards the DL MAC CE to remote UE 904. In this example, when the base station wants to send a recommended bit rate MAC CE to a remote UE, the base station should not apply the existing LCID for recommended bit rate MAC CE in the MAC subheader. Otherwise, the relay UE would assume that the recommended bit rate MAC CE is for the relay UE itself, rather than for the remote UE.

To avoid the ambiguity, the recommended bit rate MAC CE for remote UE is assigned with a distinct SL LCID, e.g., SL LCID set as 60. Here, the DL MAC CE is referred to as “relay-specific recommended bit rate” since it is used only in the SL relay scenario. When relay UE 902 checks DL MAC subheader and find the DL LCID value is 47, relay UE 902 knows that this MAC payload includes MAC CE for “recommended bit rate”, and thus in SL transmission (from relay UE 902 to relay UE 903) relay UE 902 selects the SL LCID value for “recommended bit rate”, i.e., 60 as specified in SL LCID table.

In this invention, method on how to deliver a DL MAC CE (recommended bit rate MAC CE) from the base station to a remote UE is proposed. The main concept is that when forwarding a MAC CE, this MAC CE needs to add adaptation layer header for routing. With the addition of adaption layer header, additional LCID is needed. For example, to forward a DL MAC CE, a new DL LCID specific for relay is needed so that when relay UE receives the DL MAC subPDU, the relay UE knows the existence of adaptation layer header, and thus can route it correctly.

The above illustrated framework can be used to carry other UL MAC CE or DL MAC CE. For example, it would be quite useful if a remote UE can send UL BSR (buffer status report) via the forwarding of the relay UE to inform gNB of its amount of uplink data available in uplink buffer. Based on the feedback from remote UE, the base station can provide sufficient resource or higher priority along the path to forward traffic of the remote UE, if remote UE has a lot of data to transmit.

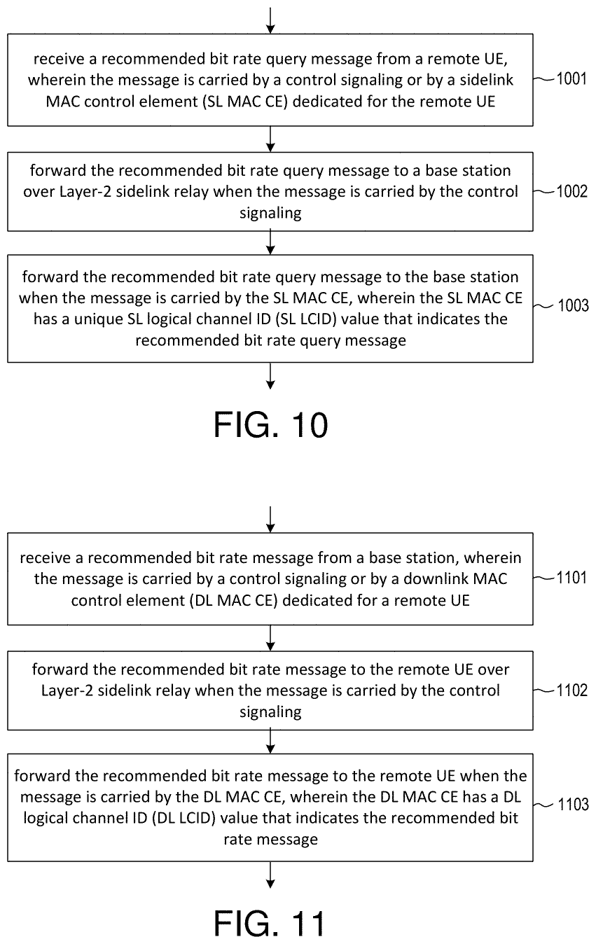

FIG. 10 is a flow chart of a method of MAC CE forwarding a recommended bit rate query message through sidelink relay in accordance with one novel aspect. In step 1001, a relay UE receives a recommended bit rate query message from a remote UE. The message is carried by a control signaling or by a sidelink MAC control element (SL MAC CE) dedicated for the remote UE. In step 1002, the relay UE forwards the recommended bit rate query message to a base station over Layer-2 sidelink relay when the message is carried by the control signaling. In step 1003, the relay UE forwards the recommended bit rate query message to the base station when the message is carried by the SL MAC CE. The SL MAC CE has a unique SL logical channel ID (SL LCID) value that indicates the recommended bit rate query message.

FIG. 11 is a flow chart of a method of MAC CE forwarding a recommend bit rate message through sidelink relay in accordance with one novel aspect. In step 1101, a relay UE receives a recommended bit rate message from a base station. The message is carried by a control signaling or by a downlink MAC control element (DL MAC CE) dedicated for a remote UE. In step 1102, the relay UE forwards the recommended bit rate message to the remote UE over Layer-2 sidelink relay when the message is carried by the control signaling. In step 1103, the relay UE forwards the recommended bit rate message to the remote UE when the message is carried by the DL MAC CE. The DL MAC CE has a DL logical channel ID (DL LCID) value that indicates the recommended bit rate message.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method by a relay user equipment (UE), comprising:
receiving a recommended bit rate query message from a remote UE, wherein the message is carried by a control signaling or by a sidelink MAC control element (SL MAC CE) dedicated for the remote UE;
forwarding the recommended bit rate query message to a base station over Layer-2 sidelink relay when the message is carried by the control signaling; and
forwarding the recommended bit rate query message to the base station when the message is carried by the SL MAC CE, wherein the SL MAC CE has a unique SL logical channel ID (SL LCID) value that indicates the recommended bit rate query message.

2. The method of claim 1, wherein the control signaling is a radio resource control (RRC) signaling, wherein the recommended bit rate query message is carried by the RRC signaling included in a radio link control service data unit (RLC SDU).

3. The method of claim 1, wherein the SL MAC CE is formed as a SL MAC subPDU having a SL MAC subheader, wherein the SL MAC subheader comprises the unique SL LCID that is different from existing LCID values.

4. The method of claim 3, wherein the SL MAC CE is formed without an associated radio link control (RLC) header or an associated adaptation layer header.

5. The method of claim 4, wherein the relay UE adds an adaptation layer header and an RLC layer header in front of the SL MAC CE to form a RLC SDU to be forwarded to the base station.

6. The method of claim 3, wherein the SL MAC CE is formed with an associated adaptation layer header and optionally an associated radio link control (RLC) header.

7. The method of claim 6, wherein the relay UE updates the associated adaptation layer header and the RLC header and forwards the SL MAC CE as an RLC PDU.

8. The method of claim 3, wherein the relay UE forwards the SL MAC subPDU to the base station as an UL MAC subPDU by converting the SL LCID to a corresponding UL LCID for the recommended bit rate query message.

9. A method by a relay user equipment (UE), comprising:
receiving a recommended bit rate message from a base station, wherein the message is carried by a control signaling or by a downlink MAC control element (DL MAC CE) dedicated for a remote UE;
forwarding the recommended bit rate message to the remote UE over Layer-2 sidelink relay when the message is carried by the control signaling; and
forwarding the recommended bit rate message to the remote UE when the message is carried by the DL MAC CE, wherein the DL MAC CE has a DL logical channel ID (DL LCID) value that indicates the recommended bit rate message.

10. The method of claim 9, wherein the control signaling is a radio resource control (RRC) signaling, wherein the recommended bit rate message is carried by the RRC signaling included in a radio link control service data unit (RLC SDU).

11. The method of claim 9, wherein the recommended bit rate message is included in a payload of the DL MAC CE, wherein the DL MAC CE has a new MAC CE type and the DL LCID in the DL MAC subheader.

12. The method of claim 9, wherein the recommended bit rate message is included in a payload of the DL MAC CE, wherein an adaptation layer header and a MAC subheader are added to form a DL MAC subPDU.

13. The method of claim 12, wherein the DL MAC CE payload, the adaptation layer header, and the MAC subheader form a SL MAC subPDU and is forwarded by the relay UE to the remote UE.

14. The method of claim 12, wherein only the DL MAC CE payload and the MAC subheader form a SL MAC subPDU and is forwarded by the relay UE to the remote UE.

15. The method of claim 12, wherein the relay UE forwards the DL MAC subPDU as a SL MAC subPDU to the remote UE by converting the DL LCID to a corresponding SL LCID for the recommended bit rate message.

16. The method of claim 15, wherein the SL LCID value indicated in a MAC subheader of the SL MAC subPDU is dedicated for recommended bit rate for the remote UE and is different from existing SL LCID values.

17. A relay User Equipment, comprising:
a receiver that receives a recommended bit rate query message from a remote UE, wherein the message is carried by a sidelink MAC control element (SL MAC CE) dedicated for the remote UE, wherein p1 the receiver receives a recommended bit rate message from a base station, wherein the message is carried by a downlink MAC control element (DL MAC CE) dedicated for a remote UE; and
a relay handling circuit that forwards the recommended bit rate query message to the base station, wherein the SL MAC CE has a unique SL logical channel ID (SL LCID) value that indicates the recommended bit rate query message, wherein
the relay handling circuit forwards the recommended bit rate message to the remote UE, wherein the DL MAC CE has a DL logical channel ID (DL LCID) value that indicates the recommended bit rate message.

18. The relay UE of claim 17, wherein the SL MAC CE is formed as a SL MAC subPDU having a SL MAC subheader, wherein the SL MAC subheader comprises the unique SL LCID that is different from existing SL LCID values.

19. The relay UE of claim 18, wherein the relay UE forwards the SL MAC subPDU to the base station as an UL MAC subPDU by converting the SL LCID to a corresponding UL LCID for the recommended bit rate query message.

20. The relay UE of claim 17, wherein the recommended bit rate message is included in a payload of the DL MAC CE, wherein an adaptation layer header and a MAC subheader are added to form a DL MAC subPDU.

21. The relay UE of claim 20, wherein the relay UE forwards the DL MAC subPDU as a SL MAC subPDU to the remote UE by converting the DL LCID to a corresponding SL LCID for the recommended bit rate message.
